(19) United States
(12) Patent Application Publication
(10) Pub. No.: US 2010/0307501 A1
(43) Pub. Date: Dec. 9, 2010

(54) DEVICE FOR ANALYZING A DIVE

(76) Inventors: Lukas Metzler, Appenzell (CH); Markus Mock, Uster (CH); Ernst Voellm, Kilchberg (CH)

Correspondence Address: WEINGARTEN, SCHURGIN, GAGNEBIN & LEBOVICI LLP, TEN POST OFFICE SQUARE, BOSTON, MA, 02109, US

(21) Appl. No.: 12/681,007

(22) PCT Filed: Sep. 30, 2008
(86) PCT No.: PCT/EP08/08295

§ 371 Date: Jul. 9, 2010

(30) Foreign Application Priority Data
Oct. 2, 2007 (DE) 10 2007 047 143.4

(51) Int. Cl. A62B 9/00

(52) U.S. Cl. 128/205.23

(57) ABSTRACT

The invention relates to a device for analyzing a dive, comprising at least one first arithmetic unit which is intended to be carried by a scuba diver during a dive. The first arithmetic unit is connected to at least one sensor that detects dive-specific parameters. The second arithmetic device comprises a memory device in which dive-specific data can be stored, the first and the second arithmetic unit comprising respective data communication devices. The arithmetic units communicate temporarily with each other to transfer dive-specific data from the first to the second arithmetic unit.

This invention concerns a device for analyzing a dive with a first arithmetic unit that is provided to be carried by a diver during a dive and with at least one second arithmetic unit, which has a memory device for storing data from a dive.

The type of device mentioned above is known, for example from U.S. Pat. No. 5,570,688, in which a dive computer can be configured from a PC over an interface. Communication takes place by means of a cable that can be connected to a dive computer and a PC.

Dive computers have many functions for detecting data on a dive and making said information available to the diver to support him in making a safe dive. German unexamined patent application DE 196 49 429 proposes a dive computer with a removable memory unit to make it easier to transfer data generated during a dive to a PC.

Recently, devices for analyzing a dive have also become known that transfer data generated during a dive by means of wireless data transfer for analysis on a PC or similar arithmetic unit. This arithmetic unit has a program in which the data are read for further analysis. Such programs most often run stationary on the diver's own PC, to which he transfers his data and analyzes it there. First, active transfer of the data to this PC is necessary.

Most of the programs necessary to analyze the dive data generated in the dive computer also use data formats that differ from the formats of the dive data generated and stored on the dive computer. When they are read and then processed on the PC, they are transferred into the data format necessary. If a diver makes several dives without transferring the data to his PC in between, there is a risk that, for example due to the limited storage capacity of the dive computer, data will be lost or damaged data will no longer be able to be transferred to the PC due to a malfunction. In addition, if the dive computer is damaged, the data stored on it is most often lost.

This invention addresses the problem of providing a device for analyzing a dive that prevents disadvantages in data transfer between the different arithmetic units and hence enhances data security as well.

The invention solves this problem with the subject of claim 1. Advantageous developments are the subject of the subclaims.

To solve the problem, the invention proposes a device for analyzing a dive with at least one arithmetic unit that is carried by a diver during a dive, whereby this first arithmetic unit is connected to at least one sensor that detects the dive-specific parameters and to a second arithmetic unit that has a memory device in which dive-specific data can be stored. Both the first arithmetic unit and the second also have a data-connection device and stay connected to one another in time by means of these data-connection devices, in order to transfer these dive-specific data from the first arithmetic unit to the second.

The device in the invention has a first arithmetic unit that is provided to be carried by a diver during a dive. These types of arithmetic units are frequently an integral part of dive computers. This first arithmetic unit is connected to at least one sensor, which is used to detect dive-specific parameters. Such sensors are usually used to detect the ambient pressure, the ambient temperature, the pressure in the diver's compressed air tank, the oxygen content of the air he breathes, the salt content of the water, the diver's physical characteristics or other dive-specific parameters that are necessary to determine the desired dive-specific data.

The device in the invention for analyzing a dive also includes a second arithmetic unit that has a memory device for storing dive-specific data. Such a second arithmetic unit is preferably a server, but can also be a mainframe or a work station. It can also be a PC or Macintosh computer or a smart phone or another suitable arithmetic unit with a memory device. The arithmetic unit preferably has several elements, like, for example PCs.

Both the first arithmetic unit and the second have a data-connection device that preferably includes both transmitting and receiving devices. They can be wireless data-connection devices, like USB or serial interfaces. Preferably, wireless data-connection devices are used. At short distances between the transmitting and receiving device, IrDA, Bluetooth or W-LAN interfaces can be provided. One preferred embodiment of the dive-analysis device, in which longer ranges are desired for the transmitting device, preferably uses GSM, UMTS, GPRS interfaces or other suitable data-connection devices.

The first arithmetic unit preferably also has devices for receiving signals from satellite-supported, position-finding systems, like GPS, DGPS or Galileo, for example. A diver can use such signals for orientation purposes. When sending an emergency call during a dive, it can be provided with positioning data that makes it much easier to find the diver in large bodies of water.

The first and second arithmetic units are also connected to one another in time by means of the data-connection devices. In a first embodiment, which preferably has wired or wireless data-connection devices with small range, the data transfer is preferably started actively. After the data transfer is finished, the connection between the first and second arithmetic units is preferably ended, until it is started again actively.

In a second embodiment of the device in the invention, the first arithmetic unit attempts, preferably as soon as transferable dive data are available, to make a connection to a second arithmetic unit and transfer these data to this second arithmetic unit. In this case, the frequency and duration of the connection between the first and second arithmetic units depends on the scope and frequency of the dive-specific data generated.

The reverse is also possible, that data are transferred, preferably independently, from a second arithmetic unit to a first. During a dive, this can preferably be the transfer of hazard messages, like storm warnings, or the transfer of software updates from the second arithmetic unit to the first.

Preferably, the device for analyzing a dive includes a third arithmetic unit, which can be connected to a second arithmetic unit. A third arithmetic unit is preferably used when the data from the second arithmetic unit must be analyzed locally, separate from the storage site. The connection between the third and the second arithmetic units is configured so that with the third arithmetic unit, access to the data stored on the second arithmetic unit is possible. Preferably, the connection between the third arithmetic unit and the second and between the second arithmetic unit and the first is configured so that the third computer can directly access the first.

With such access, preferably both the data in the second arithmetic unit and the first are protected from unauthorized access, preferably by means of a password necessary to make the connection or another suitable measure. In one especially preferred embodiment, access to the data is possible only by means of a data key.

Another especially preferred embodiment of the device for analyzing a dive also has a fourth arithmetic unit, which manages access to data on the second or first arithmetic unit. Here, the device is configured so that authorization for access to the data is dependent on the authorizations filed in the fourth arithmetic unit.

To analyze the data, appropriate programs preferably provide functions for graphic representation of the data generated during the dive, such as the dive depth, the ambient temperature or the physical data, like the nitrogen saturation of the tissues or the partial oxygen pressure of the air the diver is breathing. Preferably functions for displaying the data recorded in a time sequence are also available and preferably adjustable.

Preferably, the device for analyzing a dive is designed so that two first arithmetic units can be connected to one another. Such a connection is an advantage, besides the possibility of transferring data after the dive, during the dive under water as well. Preferably, a first arithmetic unit therefore also includes data-transfer devices, by means of which data can be transferred between two first arithmetic units both above and under water. Data transfer under water can be used during the dive for communication with dive partners, but preferably hazard information is also transferred to a dive partner's computer and can be displayed there.

In one preferred embodiment, the first arithmetic unit in the system is designed so that it is in a position to consider data transferred from the first arithmetic unit of the dive partner when processing and displaying information for the diver. For example, the next decompression stop necessary displayed on both dive computers when surfacing can be coordinated between the first two arithmetic units so that the next decompression stop necessary for a diver will be displayed on both dive computers.

The data-connection device in the invention on the first arithmetic unit is preferably also used to receive measured values from sensors that are placed in the diver's gear. In one preferred embodiment, there is a sensor that detects the respiratory rate on the diver's air-supply device and sends the dive-specific data to the first arithmetic unit for detection.

In another preferred embodiment, the first arithmetic unit has a data-connection device, which is suitable for sending control signals to devices in the diver's gear. Here, control signals for the diver's gear, like for example for respiratory rates are generated in the first arithmetic unit and sent to a corresponding receiving device arranged accordingly.

To send data under water, which is preferably done over electromagnetic long waves or ultrasound waves, especially at ranges of more than 10 meters, takes very high-power transmitting devices. To build such transmitters into a device preferably worn on the diver's wrist is also difficult because of the size necessary, especially for their power supply. Preferably, one preferred embodiment of the device for analyzing a dive therefore includes a transmitter that is placed on the diver, preferably on his compressed air tank, and has data-connection devices that can be connected to the data-connection devices of the first arithmetic unit.

In one preferred embodiment, the device for analyzing a dive is designed so that the data that are processed in a first arithmetic unit are in the data format that is used to analyze the specific dive data generated. The advantage is that it is not necessary to convert the data into another format over an interface. This also reduces the potential for data loss.

Preferably, the depiction of the dive data on the dive computer that is connected to the first arithmetic unit corresponds to the data on a second or third arithmetic unit on which the later analysis takes place.

This also makes it easier to correct the data and makes it possibly to transfer the data back to the first arithmetic unit.

Preferably, the software on the first, second and third arithmetic units is designed to be uniform. A web browser is preferably used as a platform for this. The data are processed and the specific dive data calculated, if it is relevant information that a diver needs during the dive, in a program in the web browser of the first device. In another preferred embodiment, the raw data detected in the dive computer, only after it is transmitted to a second arithmetic unit, is prepared there and made available to the diver for analysis.

Other advantages, features and applications of this invention will be seen from the following description, along with the figures.

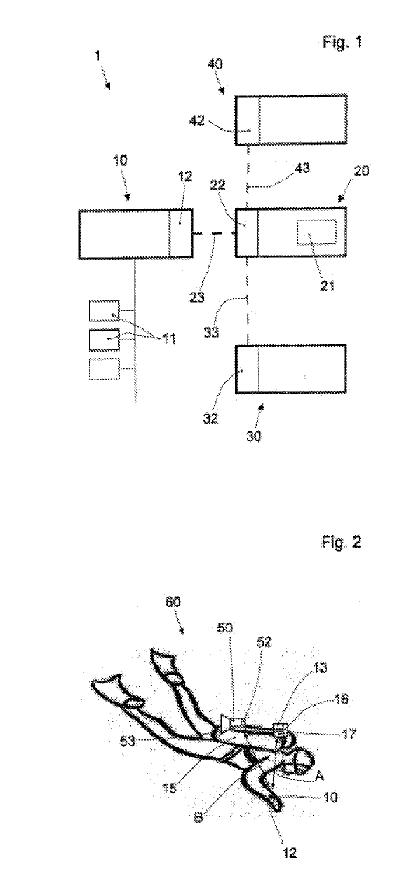

FIG. 1 shows an example of an embodiment of the device in the invention for analyzing a dive and

FIG. 2 shows a diver who uses an example of embodiment of the device in the invention.

FIG. 1 shows an example of an embodiment of the device 1 in the invention for analyzing a dive. The device includes an arithmetic unit 10 that is designed so that a diver can carry it with him during a dive. This first arithmetic unit 10 is connected to several sensors 11, which include dive-specific parameters during the dive, and transfers them to the first arithmetic unit 10. The first arithmetic unit 10 also has a data-connection device 12, which is used to send and receive data.

The device 1 also includes a second arithmetic unit 20, which has a memory device 21 for storing dive-specific data. The second arithmetic unit 20 also includes a data-connection device 22, which is used to second and receive data. The data-connection devices 12 and 22 are also designed so that they can exchange data over a data connection 23. The device for analyzing a dive 1 also has a third arithmetic unit 30 with a data-connection device 32. The third arithmetic unit 30 can be connected to the second arithmetic unit 20 via a data connection 33 to transfer data over this data-connection device 32.

The device 1 in the invention also has a fourth arithmetic unit 40 with a data-connection device 42, which manages access to the data in the second or first arithmetic unit 20, 30. Access to the data in the first arithmetic unit 10 also takes place via the second arithmetic unit 20, which is why the fourth arithmetic unit can be connected to the second arithmetic unit via a data connection 43.

FIG. 2 shows a diver 60, who is using an example of embodiment of the device in the invention. The view in FIG. 2 shows no overall sample device 1, since the second and third arithmetic units are not shown here. The diver 60 wears the first arithmetic unit 10 with the data-connection device 12 on his arm. A sensor 13, which detects the diver's 60 respiration rate, is placed on the air-outtake of a breathing device 15. The control device 16 of the breathing device 15 includes a data-connection device 17, which receives control data from the data-connection device 12 of the first arithmetic unit 10 and uses this control data to control the breathing device 15. The data transfer is symbolized by arrow A.

The diver's 60 control device 16 also has a transmitting device 50, which detects a data-connection device 52, and a battery 53. The data-connection device 52 of the transmitting device 50 receives data from the data-connection device 12 of the first arithmetic unit 10, as shown by arrow B. The information transferred in this way is amplified in the transmitting device 50 and sent out at a higher intensity.

1. A device for analyzing a dive with, comprising:
at least one first arithmetic unit which is provided to be taken with a diver during a dive,
whereby this first arithmetic unit is connected to at least one sensor that detects the dive-specific parameters,
at least one second arithmetic unit, which has a memory device in which dive-specific data can be stored:
characterized by the fact that both this first and this second arithmetic unit have a data-connection device and
this first and second arithmetic unit are connected to one another in time by means of these data-connection devices, in order to transfer dive-specific data from this first arithmetic unit to the second.

2. The device for analyzing a dive in claim 1, characterized by the fact that the device has at least one third arithmetic unit, which can be connected to the second arithmetic unit (20).

3. The device for analyzing a dive in claim 1, characterized by the fact that the connection between the third and second arithmetic units and between the second and first arithmetic units is configured so that direct access can be gained from the third arithmetic unit to the first arithmetic unit.

4. The device for analyzing a dive in claim 1, characterized by the fact that the data on the first and/or second arithmetic units are protected from unauthorized access.

5. The device for analyzing a dive in claim 4, characterized by the fact that a password or data key is necessary to access data.

6. The device for analyzing a dive in claim 2, characterized by the fact that the device has a fourth arithmetic unit which manages access to the data in the second or first arithmetic unit.

7. The device for analyzing a dive in claim 1, characterized by the fact that the first two arithmetic units can be connected to one another.

8. The device for analyzing a dive in claim 1, characterized by the fact that the data-connection device in the first arithmetic unit is suitable for transferring data above water.

9. The device for analyzing a dive in claim 1, characterized by the fact that the data-connection device in the first arithmetic unit is suitable for transferring data under water.

10. The device for analyzing a dive in claim 4, characterized by the fact that data from a dive partner is considered when detecting dive-specific data.

11. The device for analyzing a dive in claim 1, characterized by the fact that the data-connection device in the first arithmetic unit is suitable for receiving measured values from sensors placed on the diver's gear.

12. The device for analyzing a dive in claim 1, characterized by the fact that a respiratory rate of the diver is detected on a compressed air tank and is sent to the data-connection device of the first arithmetic unit.

13. The device for analyzing a dive in claim 1, characterized by the fact that control signals for devices in the diving gear are generated in the first arithmetic unit.

14. The device for analyzing a dive in claim 1, characterized by the fact that the data-connection device of the first arithmetic unit is suitable for sending control signals for devices in the diving gear.

15. The device for analyzing a dive in claim 1, characterized by the fact that high-power transmitters are attached to the diver's gear to send data under water and can be connected to the first arithmetic unit.

16. The device for analyzing a dive in claim 1, characterized by the fact that the first arithmetic unit also has devices for receiving signals from satellite-supported systems for position-fixing.

17. The device for analyzing a dive in claim 1, characterized by the fact that the dive-specific data in the first and second arithmetic units have the same format.

18. The device for analyzing a dive in claim 1, characterized by the fact that the views of the data in the first and second arithmetic units are shown in the same way.

19. The device for analyzing a dive in claim 18, characterized by the fact that a web browser is used as a platform for displaying data.

20. The device for analyzing a dive in claim 1, characterized by the fact that the dive-specific data are processed in the first and/or second arithmetic unit.

21. The device for analyzing a dive in claim 2, characterized by the fact that:
the device has at least one third arithmetic unit, which can be connected to the second arithmetic unit;
the connection between the third and second arithmetic units and between the second and first arithmetic units is configured so that direct access can be gained from the third arithmetic unit to the first arithmetic unit;
the data on the first and/or second arithmetic units are protected from unauthorized access;
a password or data key is necessary to access data;
the device has a fourth arithmetic unit which manages access to the data in the second or first arithmetic unit;
the first two arithmetic units can be connected to one another;
the data-connection device in the first arithmetic unit is suitable for transferring data above water;
the data-connection device in the first arithmetic unit is suitable for transferring data under water;
data from a dive partner is considered when detecting dive-specific data;
the data-connection device in the first arithmetic unit is suitable for receiving measured values from sensors placed on the diver's gear;
a respiratory rate of the diver is detected on a compressed air tank and is sent to the data-connection device of the first arithmetic unit;
control signals for devices in the diving gear are generated in the first arithmetic unit;
the data-connection device of the first arithmetic unit is suitable for sending control signals for devices in the diving gear;
high-power transmitters are attached to the diver's gear to send data under water and can be connected to the first arithmetic unit;
the first arithmetic unit also has devices for receiving signals from satellite-supported systems for position-fixing;
the dive-specific data in the first and second arithmetic units have the same format;
the views of the data in the first and second arithmetic units are shown in the same way;
a web browser is used as a platform for displaying data; and
the dive-specific data are processed in the first and/or second arithmetic unit.
